(19) United States
(12) Patent Application Publication
(10) Pub. No.: US 2019/0219833 A1
(43) Pub. Date: Jul. 18, 2019

(54) PROJECTION ONTO MOVEABLE PARTICULATE COLUMN TO GENERATE MOVABLE VOLUMETRIC DISPLAY

(71) Applicant: Asher Young, New York, NY (US)

(72) Inventor: Asher Young, New York, NY (US)

(21) Appl. No.: 15/870,202

(22) Filed: Jan. 12, 2018

(51) Int. Cl. G02B 27/22

(52) U.S. Cl. CPC G02B 27/2292

(57) ABSTRACT

Examples described herein include systems for generating holographic representations of subjects. For example, multiple projectors may be arranged to project images on a column of particulates. The column of particulates may be moveable—e.g., by moving a gantry supporting a particulate generator. In this manner, holographic representations of subjects (e.g., humans, characters) may be generated which may be moved about a venue (e.g., a stage).

### TECHNICAL FIELD

Examples described herein relate to volumetric display systems. Examples of systems are described which may provide a moveable column of particulates and projectors to project images on the column of particulates from multiple angles to generate a three dimensional holographic representation of a subject.

### BACKGROUND

Holographic imagery has a rich history in participatory media. One of the earliest devices was the Magic Lantern developed in the 17^{th} century by Christiaan Huygens. The device consisted of a lens, reflector, and light, functioning as one of the first iterations of a slide projector. Initially used as an education tool, it was later incorporated into Horror Theater, which came to be known as Phantasmagoria. This is one of the first instances of a “hologram” as imagined today. These presentations had tremendous power over their audiences.

Pepper's Ghost is the most common version of a hologram that people are exposed to today. Akin to the magic lantern, the effect produces a ghostly apparition for the viewer. The system consists of a light source, two identical rooms offset at ninety degrees, and a transparent screen often made of glass set at a forty-five degree angle. When the light is illuminated in both rooms, the figure appears to be in the onstage room via the reflection in the glass creating the illusion of a ghostly figure for an audience looking through the glass. Whereas the Magic Lantern effect works for only static imagery, Pepper's ghost allows movement, leaving the potential for interaction between an onstage performer and the apparition. This technique continues to be utilized in modern productions that use a very thin Mylar instead of glass in conjunction with a modern projector generating a high definition image.

### BRIEF DESCRIPTION OF THE DRAWINGS

FIG. 1 is a front schematic view of a volumetric display system in accordance with the present disclosure.

FIG. 2 is a top plan view of the volumetric display system of FIG. 1, and in accordance with the present disclosure.

FIG. 3 is a schematic diagram of a control system for volumetric displays arranged in accordance with examples described herein.

### DETAILED DESCRIPTION

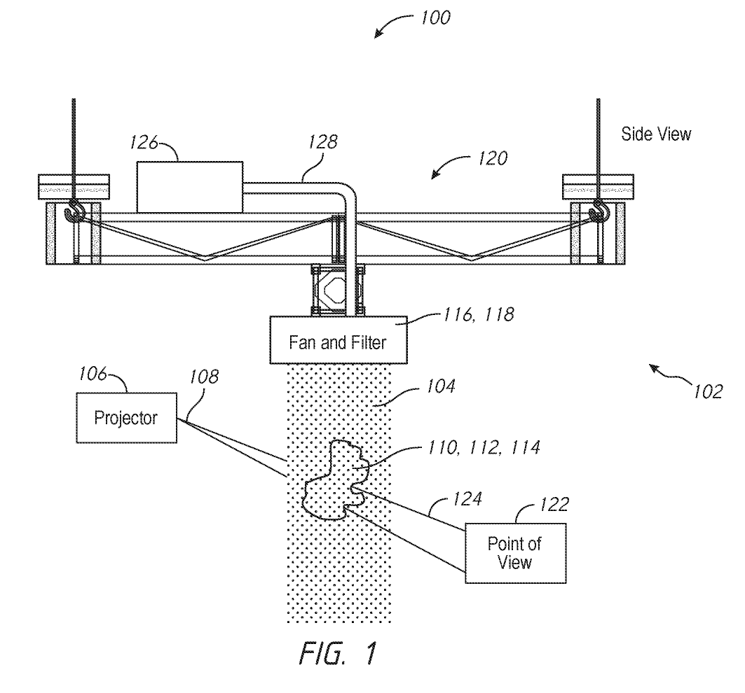

FIG. 1 is a front schematic view of a volumetric display system 100 in accordance with examples described herein. FIG. 1 illustrates a particulate generator 102, a column of particulates 104, a projector 106, angle 108, an image 110, a subject 112, a hologram 114, a fan 116, a filter 118, a gantry 120, a point of view 122, angle 124, a particulate production device 126, and particulate conduit 128.

The system 100 may include a particulate generator 102 including a particulate production device 126 (e.g. a fog machine) which produces particulates guided by a particulate conduit 128, as the particulate generator 102 generates a column of particulates 104 (e.g. fog, haze, water droplets, chemicals, or combinations thereof). A projector 106 is positioned at angle 108 about the column of particulates 104. The projector 104 projects an image 110 of a subject 112 at the respective angle 108 onto the column of particulates 104 such that a hologram 114 representing the subject 112 is generated on the column of particulates 104. The hologram 114 is viewable from a point of view 122 disposed at angle 124 to the column of particulates 104. The particulate generator 102 may include a fan 116, a filter 118, and a gantry 120.

The particulate generator 102 may include a particulate production device 126 (e.g. a fog machine), and a particulate conduit 128 guiding the particulates to a fan 116 that may propel the particulates through a filter 118. The fan 116 may be a high-powered fan in order to generate sufficient force to propel the particulates and create the column of particulates 104. The particulates may include, for example, vapor particles. The filter 118 may remove and/or reduce turbulence from an airstream, producing a smooth column of air. Without the filter 118 the blades of the fan 116 might create buffering in the air as they cut through the air, which can prevent and/or impede the image 110 from forming properly on the column of particulates 104. Thus, the filter 118 may provide a laminarized stream that allows for a more resolved image 110.

The column of particulates 104 may be implemented using fog, haze, water droplets, vapor particles, gaseous chemical compounds, or other types of particles and/or particulates which are emitted by the particulate generator 102 and driven by the fan 116. Generally, as shown in FIG. 1, the particulates may be driven downward by the fan 116, however in other examples, columns of particulates may be generated by propelling particulates in any of a variety of directions (e.g., upwards, sideways, etc.). The column of particulates may be filtered through the filter 118 which, for example, might include a series of tubes such that once the particulates pass through the filter 118 they are traveling in a generally straight direction away from the particulate generator 102. By passing the particulates through the filter 118, the column 104 may be able to be produced with a relatively definitive outer edge (e.g., a high percentage of the particulates remain within a maximum radial distance from a vertical axis of the projector). In contrast, if the particulates were traveling at random angles the walls of the column would not be well defined. A column of particulates 104 that doesn't have well-defined walls may be beneficial in some circumstances depending on the desired effect, e.g. if the hologram is depicting a ghost then hazy images might be preferred. The use of particulates that are driven by the fan 116 through filter 118 allows the column of particulates to be a continuously regenerating medium, which may be advantageous for allowing movement of the column of particulates 104 and the hologram 114. In some examples, the column of particulates 104 might be formed inside of a transparent container such as a plastic cylinder or translucent fabric, and/or the column of particulates 104 might be replaced by a static medium such as a solid plastic cylinder.

The projector 106 may be positioned to project an image at angle 108 relative to the column of particulates 104. The projector 106 may be positioned, for example, directly opposite the point of view 122 positioned at angle 124 relative to the column of particulates 104. The positioning of the projector 106 opposite the point of view 122 may allow the projector 106 to form an image 110 that resolves for a viewer at the point of view 122. In some examples, multiple projectors 106 may be each positioned opposite various points of view 122 such that a holographic representation 114 (e.g., a hologram) can be viewed from multiple (e.g., any) position around the column of particulates 104, with each point of view 122 seeing a perspective of the subject 112 as if it were actually there. The angle 108 between the projector 106 and the column of particulates may be broken down or expressed in terms of various coordinate systems. In some examples, the position of the projector 106 may be expressed in terms of r₁, θ₁, φ₁, with r₁ being a radial distance between the projector 106 and a reference point on a vertical axis of the column of particulates 104, θ₁ being a polar angle between a light path (e.g., the light path between the projector 106 and the column of particulates 104) and the vertical axis, and φ₁ being an azimuth angle measured from an orthogonal projection of the light path onto a reference plane that passes through the reference point and is orthogonal to the vertical axis. In such a system, angle 108 would be represented by φ₁.

An image 110 may be projected onto the column of particulates 104 by the projector 106. Each of the images 110 is projected from an angle 108 which shows a view of a subject 112 from a perspective (e.g. a point of view) associated with the angle 108 of the projector and the angle 124 of the point of view 122 of the viewer. As an example, an image may be formed from a video file created by a video camera recording a subject 112 in a typical manner. The image 110 projected onto the column of particulates 104 by a projector 106 positioned directly behind the column of particulates would portray a front perspective of the subject 112 to a person viewing the image 110 from an angle 124 of a point of view 122 directly in front of the column of particulates 104. That image 110 would have been captured by the video camera positioned directly in front of the subject 112. So if the subject 112 were a person, a video camera directly in front of the person would film the person's face, then the projector 106 would project that image 110 of the person's face from directly behind the column of particulates 104, and the viewer sitting at a point of view 122 directly in front of the column of particulates 104 would see the person's face. At least in part simultaneously, a video camera positioned behind the person would film the person's back, and a second projector 106 would project an image 110 of the person's back from directly in front of the column of particulates 104, and a viewer sitting at a point of view 122 directly behind the column of particulates 104 would see the person's back. The image data can be recorded by a camera and projected by the projector in near-simultaneous fashion for a live broadcast, recorded and then later transmitted, produced via computer animation, or produced using any other technique. Note that recording of the images (e.g., using one or more cameras) may be temporally separate from the projection. For example, the images may be captured during one or more recording sessions and stored. Later, the images may be projected by projectors described herein for one or more performances, for example. Also note that in order to gain location data an additional camera or motion tracking system records the location within the gantry's 120 movable area.

Subjects described herein generally refer to one or more things which are depicted by images described herein. For example, the subject 112 is the thing that is depicted by the image 110. Subjects may include a real-world person or thing. In some examples, such as in the context of computer animation the subject may include a 3D digital model of an object that exists in a digital environment. In this case, an image 110 of the subject 112 would depict a digitally produced rendering of the 3D model. Any of a variety of subjects may be used in examples described herein to provide a holographic representation of the subject on a column of particulates. For example, one or more people, animals, plants, scenes, buildings, places, devices, animated characters, or combinations thereof may be used to implement subjects described herein.

A holographic representation 114 is formed by the images 110 received from the various projectors 106. Holographic representations described herein generally refer to a volumetric display of a subject. The holographic representations described herein may be generated using images projected on a column of particulates from multiple angles. Holographic representations described herein may also be described as holograms. In this manner, holograms or holographic representations described herein include 3D representations of objects, including the representations formed on volumetric displays. In some embodiments, the holographic representation 114 may be viewable from 360°, e.g., from any position around the column of particulates 104. Holographic representations and/or holograms described herein may include a multitude of 2D images being formed simultaneously on a 3D medium with each image providing a unique perspective of a subject, with the perspective of the subject corresponding to the perspective of an observer.

The fan 116 may be a high-powered fan 116 having one or more rotating blades that may create a current of air for driving particulates through the filter 118. Filters 118 such as laminar filters with greater filtering capability, e.g., longer tubes, typically require a relatively higher powered fan 116 to drive the particulates through the filter 118. In some examples, the fan 116 may produce sufficient force for producing a relatively smooth column of particulates 104 and allow the column of particulates 104 to be moved with sufficient speed.

The filter 118 may be a laminar filter designed to create a laminar air flow having a relatively uniform velocity and direction. The filter 118 may have a series of narrow linear tubes such that once the particulates pass through the tubes, they are traveling in a generally straight direction away from the particulate generator 102.

The gantry 120 supports the particulate generator 102 and allows it to be translated from one position to another, consequently moving the column of particulates 104 and providing automation thereof. In this manner, holographic representations appearing in the column of particulates 104 may be moved around a venue (e.g., a stage). The gantry 120 can be set up to support the particulate generator 102 at a number of heights from the floor, such as 5′, 8′, 10′, or 15′. Greater distances between the floor and the ceiling in a venue may provide advantageous room for the gantry 120 to include additional infrastructure used for the movement of the particulate generator 102. The gantry 120 can be implemented with either 1 axis movement, 2 axis movement, or 3 axis movement. In some examples, 2 axes of movement may allow the gantry to move the column of particulates 104 in the x-y plane such that the animation (e.g., movement of the subject 112 depicted in the holographic representation 114) can be synchronized with the translation/movement of the column of particulates to create the illusion of, for example, a person walking on the stage. To produce such an illusion, the translation of the column of particulates 104 in the x-y plane may be synchronized with the apparent speed and direction of movement of the holographic representation 114. Any scaling of the holographic representation 114 relative to the subject 112 may be accounted for.

Movement provided by the gantry 120 can be implemented in a variety of ways. In some examples, a Cartesian x/y gantry 120 may provide movement in the x-y plane using a series of servo motors driving a rubber timing belt along a track to move the particulate generator 102. Servo motors may provide an advantage over other types of motors because they are relatively powerful, and very precise, e.g., having a millimeter of control tolerance. In some examples, a toothed rubber belt may be used to drive the motion in each axis, allowing for low operating volume. Use of a rubber belt may be beneficial because it may decrease operating noise, which may be undesirable in many forms of artistic productions involving the image production system 100. Other gantry systems using a chain may be noisier, but can still serve the same purpose. In some examples, the gantry 120 may include a linear actuator in place of the rubber timing belt; a motorized vehicle adapted to drive on a floor or ceiling; a drone or other flying device; a crane or robotic arm; a parallel manipulator such as a delta robot with 1, 2, 3, 4, or more robotic arms; and/or the gantry can be excluded all together with either a static particulate generator 102, or an array of particulate generators 102 providing movement of the column of particulates 104. In some examples, the gantry 120 may provide 1, 2, or 3 axes of movement for the particulate generator 102.

The point of view 122 represents a hypothetical location of a viewer, typically a person, viewing the holographic representation 114. For the sake of simplicity, only one point of view 122 is shown in FIG. 1, but examples described herein may include any number of points of view 122 positioned anywhere 360° around the column of particulates 104 with any number of projectors 106 associated with the points of view 122. Each point of view 122 may be positioned directly opposite a corresponding projector 106 such that the image 110 formed by the projector 106 is the image seen from that point of view 122 (e.g., the viewer stares into the projector with the column of particulates 104 directly in between them). Of course, viewers may be positioned between the hypothetical “points of view” associated with each projector. Those viewers may also have an acceptable viewing experience in examples described herein. In addition, viewers may be positioned in front of the projectors 106, and in such cases an obstruction may be avoided by varying the angle of projection and positioning the projectors above or below the viewers. In some examples, the images 110 formed by the projectors 106 not directly opposite the point of view 122 may not resolve from the point of view 122. Varying particulate size allows for the images projected by these other projectors not to resolve (e.g. come into view) for the viewer at the point of view 122. This advantageously avoids creating muddled perspectives.

The point of view 122 is positioned at angle 124 relative to the column of particulates 104. The angle 124 may be broken down or expressed in terms of various coordinate systems. In some examples, the position of the point of view 122 may be expressed in terms of r₂, θ₂, φ₂, with r₂ being a radial distance between the point of view 122 and a reference point on a vertical axis of the column of particulates 104, θ₂ being a polar angle between a line of sight (e.g., the line between the point of view 122 and the column of particulates 104) and the vertical axis, and φ₂ being an azimuth angle measured from an orthogonal projection of the line of sight onto a reference plane that passes through the reference point and is orthogonal to the vertical axis. In some examples, angle 124 may be represented by φ₂. In some examples, the angle 108 corresponds with the angle 122 such that φ₂ is the negative of φ₁ (φ₁ being described above).

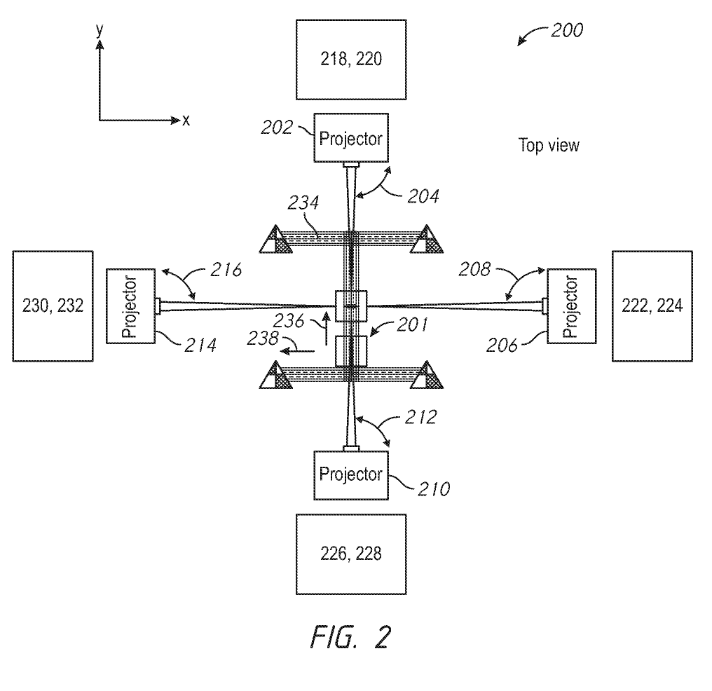

FIG. 2 is a top plan view of a volumetric display system 200 in accordance with examples described herein. FIG. 2 illustrates a particulate generator 201, a first projector 202 positioned at a first angle 204, a second projector 206 positioned at a second angle 208, a third projector 210 positioned at a third angle 212, a fourth projector 214 positioned at a fourth angle 216, a first point of view 218 positioned at a first angle 220, a second point of view 222 positioned at a second angle 224, a third point of view 226 positioned at a third angle 228, a fourth point of view 230 positioned at a fourth angle 232, a gantry 234, a first arrow 238 indicating a first direction of movement of the gantry 234 along the x-axis, and a second arrow 236 indicating a second direction of movement of the gantry 234 along the y-axis.

The system 200 may include a particulate generator 201 creating a column of particulates (not shown in this view). There are four projectors 202, 206, 210, 214 each disposed at respective angles 204, 208, 212, 216 to the particulate column and projecting an image thereon. There are four points of view 218, 222, 226, 230 of the hologram created by the system 200, each of the four points of view 218, 222, 226, 230 disposed at respective angles 220, 224, 228, 232 to the particulate column. The gantry 234 is shown suspending the particulate generator 201 and controlling its motion in the x-y plane, with the first arrow 238 indicating that the gantry 234 can move the particulate generator 201 in the x-axis direction, and the second arrow 236 indicating that the gantry 234 can move the particulate generator 201 in the y-axis direction. In some examples, additional points of view and projectors may be provided. For example, 8, 12, 15, or 100 projectors may be used with potentially infinite points of view corresponding to the projectors, with 1 or more points of view associated with each projector. The angles corresponding to the projectors may be evenly spaced or grouped together with a patterned spacing, and may be positioned 360° around the column of particulates or some fraction thereof, e.g. 270°, 200°, 1800, or 90°. Other numbers of points of view, projectors, and/or angles may be used in other examples. In other examples, the projectors can be located either behind or in front of the viewers, with factors like lenses used and projector specifics allowing for these variations.

The four projectors 202, 206, 210, 214 each project an image on the column of particulates, with the projector 202 providing a first image corresponding to a front view of the subject, the projector 206 providing a second image corresponding to a right profile view of the subject, the projector 210 providing a third image corresponding to a back view of the subject, and the projector 214 providing a fourth image corresponding to a left profile view of the subject. The first image provided by the projector 202 may be viewed from the point of view 226, the second image provided by the projector 206 may be viewed from the point of view 230, the third image provided by the projector 210 may be viewed from the point of view 218, the fourth image provided by the projector 214 may be viewed from the point of view 222.

As the gantry 234 moves the column of particulates, the projectors 202, 206, 210, 214 may track the movement of the column of particulates. This may be implemented, for example, with the projectors 202, 206, 210, 214 remaining stationary and projecting in a manner which tracks the column of particulates and adjusts the video accordingly. Other potential methods of tracking may be accomplished by connecting the projector to a U-shaped yoke fixed to the sides of the projector providing a first axis of rotation, with the base of the yoke mounted to a base by a single bolt around which the yoke can be rotated providing a second axis of rotation, or with the projectors sliding on a track to help maintain the alignment between the projector and its corresponding point of view, e.g., the alignment between the projector 202 and the point of view 226. Implementation of the tracking system may be influenced by various factors such as the number of projectors used in the system 200, the distance between the projectors and the stage area (e.g., the area within which the gantry will be moving), and the distance between the points of view (e.g., the audience or viewers) and the stage area. Tracking between the projectors 202, 206, 210, 214 and the column of particulates may also be accomplished in other ways in other examples—e.g., by changing a direction of projection without physically moving the projector. In some examples, the projectors may be moved in x, y, and/or z directions.

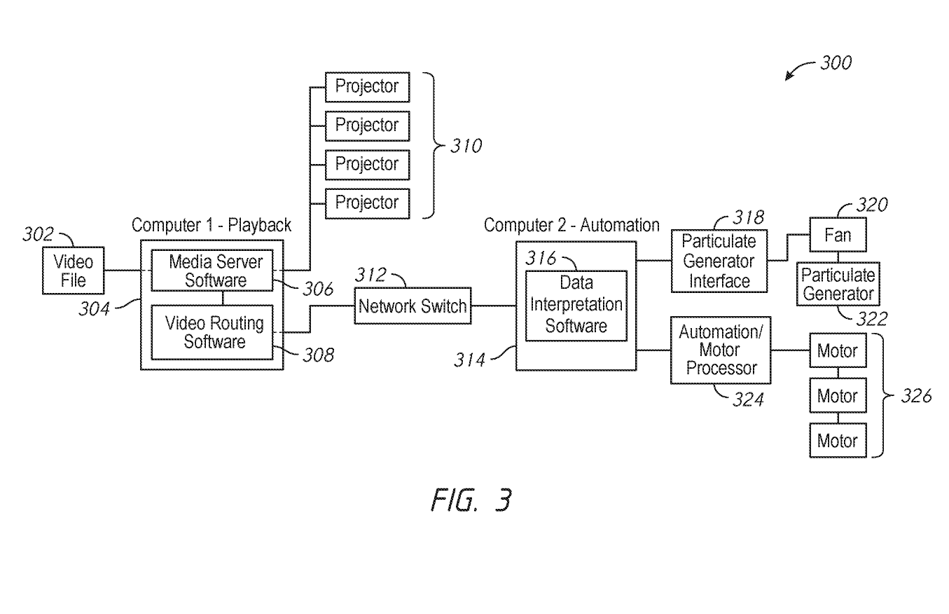

FIG. 3 is a schematic diagram of a volumetric display system 300. FIG. 3 illustrates a video file 302, a first computer 304, media server software 306, video routing software 308, four projectors 310, a network switch 312, a second computer 314, data interpretation software 316, a particulate generator interface 318, a fan 320, a particulate generator 322, an automation/motor processor 324, and three motors 326.

The system 300 may include a video file 302 being provided to a first computer 304 (e.g. first computer 304 may be a content playback computer and streaming mechanism with access to video files). The information in the video file 302 may be provided, for example, over a wired or wireless communication connection, or via internal storage. The first computer 304 may process the video file 302 using media server software 306 to produce image data having a format compatible with the projectors 310. Each of the four projectors 310 may receive image data (e.g., over a wired or wireless communication connection) corresponding to the image depicting the perspective associated with the position of the particulate projector 310. The images may be warped and corrected to handle keystoning, or have other projection correction applied based on projector placement and implementation specifics. Software for sharing image files (e.g., a syphon stream program may be used for video routing software 308) may also receive the video file 302 and provide data from the video file 302 to the network switch 312, which aids in data routing. The data is sent from the network switch 312 to a second computer 314 (e.g. second computer 304 may be a control server/computer, that either receives control video stream or decoded data via the interpreter, which could be on either first computer 304 or second computer 314) running a data interpretation software 316. The data interpretation software 316 interprets the data received from the first computer 304 via the network switch 312 and provides a portion of the data (reconfigured as necessary for certain outputs) to a particulate generator interface 318 (e.g., a DMX Dongle). The particulate generator interface 318 may provide a signal based on this data to the fan 320 and the particulate generator 322 in order to control these components and produce the column of particulates. The data interpretation software 316 may also provide a portion of the data received from the first computer 304 via the network switch 312 to the automation/motor processor 324 (e.g. automation/motor processor 324 may be an automation control processor that receives axis data from the second computer 314 and has built in processes and safeguards for the automation portion, in some examples it may be a Beckhoff processor), which may use this data to provide a control signal to the three motors 326. The three motors 326 control the gantry, thus providing automated movement of the particulate generator 322 and the column of particulates. In some examples, the motors 326 receive power and data to indicate location, and the motors 326 return location data back to the automation/motor processor 324 to tell it where it is located to ensure location accuracy.

In this manner, note that control information for a particulate generation system and/or a gantry may be encoded in a video file. Playback of the video file may provide the control data for control of the particulate generator and movement of the particulate column. While certain computing systems and software components are described in FIG. 3, it is to be understood that the computing systems used to implement systems described herein may be quite flexible. For example, although two computing systems 304 and 314 are shown in FIG. 3, in some examples, a different number of computing systems may be used (e.g., a single computing system and/or three or more computing systems). Computing systems described herein generally include one or more processing units (e.g., processors, central processing units (CPUs), graphics processing units (GPUs), controllers, and/or custom circuitry) and memory encoded with executable instructions for performing actions described herein (e.g., communicating image data, decoding automation data, etc.). The executable instructions may be executed by the one or more processing units to perform the actions described herein. The executable instructions may be referred to as software, and the execution of the software by the one or more processing units may be referred to as running the software.

The software 306, 308, 316 may allow components of the system 300 to work in tandem. The data controlling the motion of the gantry may be provided together in real time alongside the video files, e.g., the control data manipulating the gantry may be provided via the same video format as the image data sent to the projectors 310. An interface associated with the software 306, 308, 316 may provide technical control over the image data and motion data. By representing the control data (e.g., the location data for where the gantry must position the particulate generator 310 with respect to time) as image sequences, and compiling the videos so that the playback system contains all the relevant information in one centralized file, the system 300 allows the interface associated with the software 306, 308, 316 to provide sufficient technical control while still being readily manipulable by a user. This method may also reduce the frequency of technical issues, increase the efficiency of data transfer, and/or increase the proficiency of the system 300 in synchronizing the motions of the holographic representation with the automated movement of the particulate generator in some examples. The latter benefit may serve to increase the visual quality of a holographic video produced by the system 300, such as the ability of the system to produce a realistic 3D representation of a moving subject (e.g. a person walking across a stage). In some examples, the system 300 may improve and/or maximize the tracking between the translation of the hologram provided by the gantry's movement of the particulate generator and the depicted translation of the subject in the holographic representation. As an example, a person depicted in a hologram as taking an 18″ step every 0.5 seconds may be moved by the gantry approximately 18″ every 0.5 seconds. Further sensitivities can also be encoded so that every single frame is considered. In some examples, the tracking between the automation provided by the gantry and the motion of the holographic image may be sufficient to produce smooth realistic 3D representations moving across a stage. In some examples, the system 300 may control internal attributes of the projectors, such as focus, zoom, etc., via network commands.

In the system 300 of FIG. 3, the video file 302 may include data for controlling the projectors 310, the gantry system controlled by the automation/motor processor 324, and the fan 320 and particulate generator 322 (e.g., through communication with the particulate generator interface 318). The video file 302 may accordingly include automation control data. For example, the automation control data may be encoded into one or more image (e.g., video) data, typically used to represent pixel values. Typical image data for a matrix of pixels, each pixel having a red, a green, and a blue value includes values for each of these components per pixel. The data controlling the motion of the gantry may utilize this same data format in examples described herein, but instead of creating an image through the various pixel values, the pixel values may represent control data for movement of the gantry. Since each pixel can have 255\hat{ }3 discrete values, the motion control data contained in the video file 302 may be able to store nuanced information while remaining quite small in file size. For reference, high definition video has a resolution of 1920 pixels wide by 1080 pixels tall, thus providing 2,073,600 individual pixels each with 255\hat{ }3 discrete values. Using video data to control the gantry and/or particulate generators described herein may allow the motion control data and image (e.g., video) content to be in a uniform format so that it may be viewed and edited within a single user interface in some examples. This may help designers to more easily implement their artistic vision in some examples.

In the example of FIG. 3, four content videos and one control video may be included in the video file 302, with five videos total. In some examples, the four content videos are HD (1920×1080 pixels), and the control video has a resolution of 1×1. Within the one pixel of the control video, the fog/fan information may be stored in one value, x axis stored in another, and the y axis automation material stored in the final value (for example, this may be accomplished using RGB (red, green, and blue) for each of the three pieces of information, respectively. So if the red pixel was a value of 25 that would be 25/255˜10% output of the column particulates. Similarly for movement, a green pixel of value 1 would equate to 1/255 of the total range of motion in the x axis. In other examples, a greater degree of control may be obtained with each of the parameters extended to their own or several pixels. In the media server there would be five videos loaded into the timeline/playback bar. The four content videos then stream out to the projector. The fifth small control video is sent to a video streaming tool that streams the video frame to the decoder and then the values of the 1×1 pixel is decoded and sent to the various components. In some examples, the reason content is synced with the motion may be because the content videos are directly tied to the control video. If an operator needs to jump ahead or behind in a timeline then the stream will just receive the pixel values being outputted by the fifth video (the control video) at a given moment. In some examples, the workflow may include a program to automatically encode the control video to be representative of the correct data. In some examples, the entire system 300 can be simplified such that all of the hardware and software are on one machine, or with part of the system 300 operating on cloud servers and/or part of the system 300 being implemented on smart phones.

Generally, video files used in examples described herein may include any number of video content clips for any number of projectors, and any number of control videos for any number of gantry systems (e.g., for controlling multiple columns of particulates) and/or particulate generators.

Example advantages of systems described herein may include that the designer can easily film a tracking sequence, run it through the pixel generation tools (e.g., which creates a control video aligned with motion), and play it back within the media server. This may be significantly faster than what was done in previous motion control systems where automation technicians would have to program in the motion of a system. The increase in speed and efficiency may allow systems described herein to streamline show implementation and even provide live broadcasting. Note that the advantages described herein are provided to facilitate an appreciation of examples of the described technology. It is to be understood that examples of the described technology may not exhibit all, or even any, of the described advantages.

From the foregoing it will be appreciated that, although specific embodiments have been described herein for purposes of illustration, various modifications may be made while remaining with the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A method comprising:
generating a column of particulates;
projecting images onto the column of particulates, wherein each of the images is projected onto the column of particulates from a respective angle, and wherein each of the images comprises a view of a subject from a point of view associated with the respective angle, wherein the images are configured to generate a holographic representation of the subject on the column of particulates; and
moving the column of particulates to move the hologram.

2. The method of claim 1, wherein generating the column of particulates comprises propelling fog through a laminar filter.

3. The method of claim 1, wherein generating the column of particulates comprises generating the column of particulates with a density configured to reflect light while remaining transparent.

4. The method of claim 1, wherein projecting images comprises projecting each image using a different projector positioned at the respective angle relative to the column of particulates.

5. The method of claim 1, wherein the images comprise a first image corresponding to a front view of the subject, a second image corresponding to a right profile view of the subject, a third image corresponding to a left profile view of the subject, and a fourth image corresponding to a back view of the subject.

6. The method of claim 1, wherein moving the column of particulates comprises playing a video including automation instructions encoded as pixel data.

7. The method of claim 1, further comprising generating the images including capturing captured images of the subject using multiple cameras positioned at the respective angles.

8. The method of claim 7, wherein generating the images further comprising scaling the captured images in accordance with a size of the column of particulates.

9. The method of claim 1, wherein the images comprise images of animated content, the method further comprising generating the images including generating the images using virtual cameras at the respective angles.

10. The method of claim 1, further comprising capturing an aerial view of the subject to provide aerial data, and wherein moving the column of particulates comprises moving the column of particulates in accordance with the aerial data.

11. A system comprising:
a particulate generator configured to generate a column of particulates;
a plurality of projectors positioned at respective angles about the column of particulates, each of the plurality of projectors configured to project a respective image of a subject at the respective angle onto the column of particulates such that a hologram representing the subject is generated on the column of particulates; and
an automation system coupled to the particulate generator and configured to move the column of particulates.

12. The system of claim 11, wherein the particulates comprise fog, haze, water, chemicals or combinations thereof.

13. The system of claim 11, wherein the particulate generator comprises:
a fog machine configured to generate the particulates;
a fan coupled to the fog machine and configured to propel the particulates; and
a laminar filter coupled to the fan and configured to form the particulates into the column of particulates.

14. The system of claim 11, wherein the respective images comprise a first image corresponding to a front view of the subject, a second image corresponding to a right profile view of the subject, a third image corresponding to a left profile view of the subject, and a fourth image corresponding to a back view of the subject.

15. The system of claim 14, wherein the plurality of projectors comprise:
a first projector configured to project the first image on a front of the column of particulates as viewed from a viewpoint;
a second projector configured to project the second image on a right side of the column of particulates as viewed from the viewpoint;
a third projector configured to project the third image on a left side of the column of particulates as viewed from the viewpoint; and
a fourth projector configured to project the fourth image on a back side of the column of particulates as viewed from the viewpoint.

16. The system of claim 14, wherein the automation system includes a computing system configured to play a control video, and wherein the control video includes automation control data encoded as pixel data, the computing system configured to decode the pixel data to recover the automation control data.

17. The system of claim 16, wherein the automation system further comprises an automation gantry coupled to the computing system and configured to move the column of particulates in accordance with the automation control data provided by the computing system.

18. The system of claim 14, wherein the respective images comprise images of the subject captured at the respective angles.

19. The system of claim 18, wherein the respective images comprise images of the subject captured with cameras positioned at the respective angles relative to the subject.

20. The system of claim 18, wherein the respective images comprise images of the subject captured with virtual cameras oriented at the respective angles relative to the subject.
